(19) United States
(12) Patent Application Publication
(10) Pub. No.: US 2026/0266541 A1
(43) Pub. Date: Sep. 10, 2026

(54) OVEN APPLIANCE UTENSIL DRYING

(71) Applicant: Haier US Appliance Solutions, Inc., Wilmington, DE (US)

(72) Inventors: Jihwan Kim, Seoul (KR); Hanul Kim, Incheon (KR); MyungGeon Chung, Seoul (KR)

(21) Appl. No.: 19/070,655

(22) Filed: Mar. 5, 2025

(51) Int. Cl. F26B 3/18

(52) U.S. Cl. CPC F26B 3/18

(57) ABSTRACT

An oven appliance includes a cabinet, a cooking chamber defined within the cabinet for cooking food items therein, and a heating element in thermal communication with the cooking chamber for providing cooking energy to the cooking chamber. A method may include performing a cooking operation in the oven appliance. The cooking operation may include activating the heating element to provide cooking energy to the cooking chamber. The method may also include receiving the utensil in the cooking chamber of the oven appliance after the cooking operation, whereby the utensil is dried in the cooking chamber of the oven appliance.

### FIELD OF THE INVENTION

The present subject matter relates generally to systems and methods for utilizing residual heat in a cooking appliance, such as to dry and/or sterilize utensils.

### BACKGROUND OF THE INVENTION

Cooking appliances generally include a cabinet, a cooking chamber defined within the cabinet, and one or more heating elements positioned and configured to provide heat to food items in the cooking chamber. During operation of the cooking appliance, the heating element(s) is or are activated to raise the temperature within the cooking chamber and sustain the elevated temperature throughout the cooking operation. Such operations consume energy to produce the heat needed to raise and sustain the temperature. When the cooking operation is completed, residual heat may continue to be present in the cooking chamber for a significant period of time, but such heat is typically wasted and not utilized. Accordingly, some portion of the energy consumed during the cooking operation is not fully utilized.

Utensils, such as food storage and handling utensils which may also be referred to as dishes, are conventionally washed by hand or in a dishwashing appliance. After washing, the utensils may require an extended time to completely dry via air drying, and it may be desirable to sterilize the utensils.

Accordingly, there exists a need for systems and methods for identifying opportunities to utilize residual heat in a cooking appliance, such as to dry and/or sterilize utensils in the cooking appliance.

### BRIEF DESCRIPTION OF THE INVENTION

Aspects and advantages of the invention will be set forth in part in the following description, or may be obvious from the description, or may be learned through practice of the invention.

In accordance with one embodiment of the present disclosure, a method of operating an oven appliance is provided. The oven appliance includes a cabinet, a cooking chamber defined within the cabinet for cooking food items therein, and a heating element in thermal communication with the cooking chamber for providing cooking energy to the cooking chamber. The method includes performing a cooking operation in the oven appliance. The cooking operation includes activating the heating element to provide cooking energy to the cooking chamber. The method also includes transmitting, from the oven appliance, a notification to a household appliance after performing the cooking operation and detecting, by the household appliance, a presence of a utensil. The method further includes receiving the detected utensil in the cooking chamber of the oven appliance, and, as a result, the utensil is dried in the cooking chamber of the oven appliance.

In accordance with another embodiment of the present disclosure, a method of drying a utensil in an oven appliance is provided. The oven appliance includes a cabinet, a cooking chamber defined within the cabinet for cooking food items therein, and a heating element in thermal communication with the cooking chamber for providing cooking energy to the cooking chamber. The method includes performing a cooking operation in the oven appliance. The cooking operation includes activating the heating element to provide cooking energy to the cooking chamber. The method also includes receiving the utensil in the cooking chamber of the oven appliance after the cooking operation, and, as a result, the utensil is dried in the cooking chamber of the oven appliance.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a perspective view of an oven appliance according to one or more exemplary embodiments of the present subject matter.

FIG. 2 provides a transverse cross-sectional view of the oven appliance of FIG. 1 taken along line 2-2 of FIG. 1.

FIG. 3 provides a front view of a system according to one or more exemplary embodiments of the present disclosure.

FIG. 4 provides a side schematic view of the exemplary system of FIG. 3.

FIG. 5 provides a perspective view of an interactive assembly according to one or more exemplary embodiments of the present disclosure which may be incorporated into a system such as the system of FIG. 3.

FIG. 6 provides a diagrammatic illustration of an oven appliance and a household appliance in accordance with one or more additional exemplary embodiments of the present disclosure.

FIG. 7 provides a diagrammatic illustration of a household appliance in communication with a remote computing device and with a remote user interface device according to one or more exemplary embodiments of the present subject matter.

FIG. 8 provides a flowchart illustrating an example method according to one or more embodiments of the present disclosure.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, terms of approximation, such as “generally,” or “about” include values within ten percent greater or less than the stated value. When used in the context of an angle or direction, such terms include within ten degrees greater or less than the stated angle or direction. For example, “generally vertical” includes directions within ten degrees of vertical in any direction, e.g., clockwise or counter-clockwise.

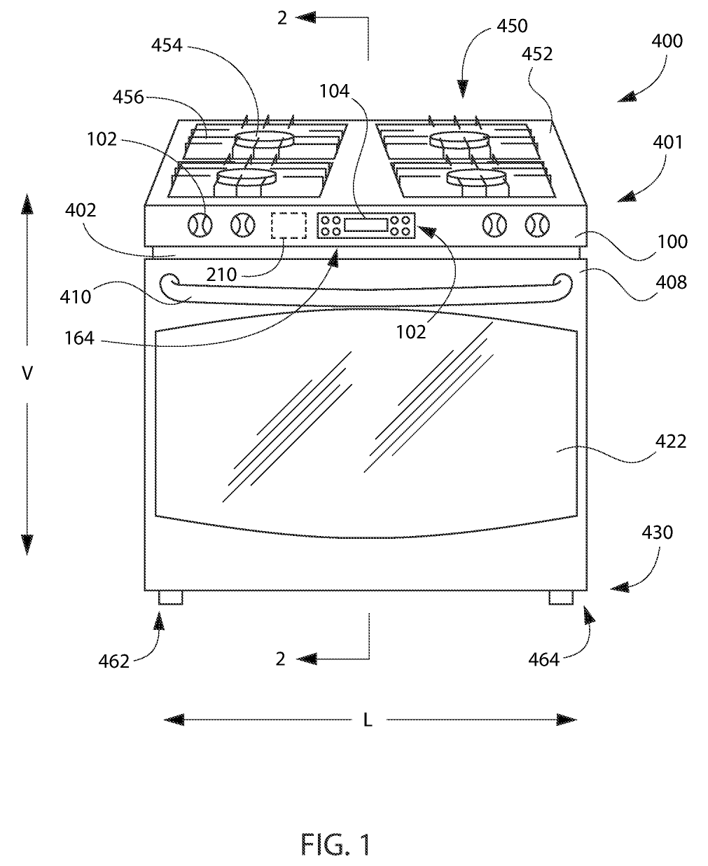

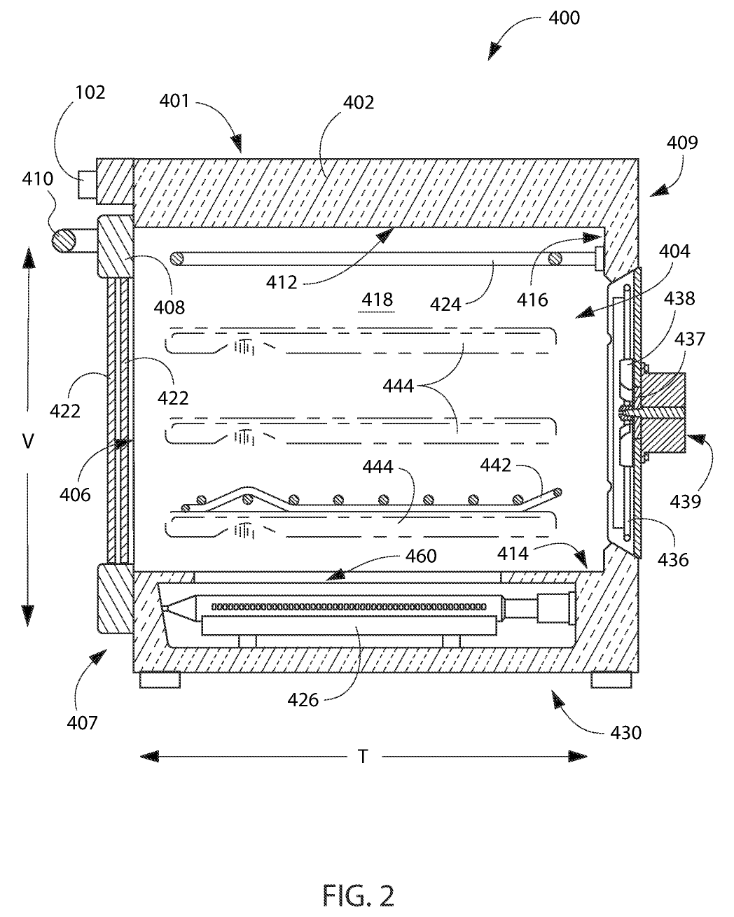

FIGS. 1 and 2 illustrate an exemplary oven appliance 400 according to an exemplary embodiment of the present subject matter. Oven appliance 400 includes an insulated cabinet 402 which defines a vertical direction V, a lateral direction L, and a transverse direction T. The vertical, lateral, and transverse directions V, L, and T are mutually perpendicular and form an orthogonal direction system. Cabinet 402 extends between a top portion 401 and a bottom portion 430 along the vertical direction V. Cabinet 402 extends between a left side 462 and a right side 464 along the lateral direction L and between a front portion 407 and a back portion 409 along the transverse direction T.

As may be seen in FIGS. 1 and 2 a user interface panel 100 and a user input device 102 may be positioned on an exterior of the appliance. The user input device 102 is generally positioned proximate to the user interface panel 100, and in some embodiments, the user input device 102 may be positioned on the user interface panel 100.

In various embodiments, the user interface panel 100 may represent a general purpose I/O ("GPIO") device or functional block. In some embodiments, the user interface panel 100 may include or be in operative communication with user input device 102, such as one or more of a variety of digital, analog, electrical, mechanical or electro-mechanical input devices including rotary dials, control knobs, push buttons, and touch pads. The user interface panel 100 may include a display component 104, such as a digital or analog display device designed to provide operational feedback to a user. The display component 104 may also be a touchscreen capable of receiving a user input, such that the display component 104 may also be a user input device in addition to or instead of the user input device 102.

Generally, the appliance may include a controller 210 in operative communication with the user input device 102. The user interface panel 100 and the user input device 102 may be in communication with the controller 210 via, for example, one or more signal lines or shared communication busses. Input/output ("I/O") signals may be routed between controller 210 and various operational components of the appliance. Operation of the appliance can be regulated by the controller 210 that is operatively coupled to the user interface panel 100. A user interface panel 100 may for example provide selections for user manipulation of the operation of an appliance, e.g., via user input device 102 and/or display 104. In response to user manipulation of the user interface panel 100 and/or user input device 102, the controller 210 may operate various components of the appliance. Controller 210 may include a memory and one or more microprocessors, CPUs or the like, such as general or special purpose microprocessors operable to execute programming instructions or micro-control code associated with operation of the appliance. The memory may represent random access memory such as DRAM, or read only memory such as ROM or FLASH. In one embodiment, the processor executes programming instructions stored in memory. The memory may be a separate component from the processor or may be included onboard within the processor. Alternatively, a controller 210 may be constructed without using a microprocessor, e.g., using a combination of discrete analog and/or digital logic circuitry (such as switches, amplifiers, integrators, comparators, flip-flops, AND gates, and the like) to perform control functionality instead of relying upon software.

The controller 210 may be programmed to operate the appliance by executing instructions stored in memory. For example, the instructions may be software or any set of instructions that when executed by the processing device, cause the processing device to perform operations. Controller 210 can include one or more processor(s) and associated memory device(s) configured to perform a variety of computer-implemented functions and/or instructions (e.g., performing the methods, steps, calculations and the like and storing relevant data as disclosed herein). It should be noted that controllers 210 as disclosed herein are capable of and may be operable to perform any methods and associated method steps as disclosed herein.

As shown in FIG. 1, oven appliance 400 includes a cooktop 450. Cooktop 450 is disposed on and is attached to or integral with cabinet 402. Cooktop 450 includes a top panel 452, which by way of example may be constructed of glass, ceramics, enameled steel, or combinations thereof. One or more burners 454 extend through top panel 452. A utensil (e.g., pots, pans, etc.) holding food and/or cooking liquids (e.g., oil, water, etc.) may be placed onto grates 456 disposed adjacent burners 454. Burners 454 provide thermal energy to cooking utensils placed on grates 456. Burners 454 can be any suitable type of burners, including e.g., gas, electric, electromagnetic, a combination of the foregoing, etc. It will be appreciated that the configuration of cooktop 450 is provided by way of example only and that other suitable configurations are contemplated.

Still referring to FIGS. 1 and 2, for this exemplary embodiment, oven appliance 400 includes an insulated cabinet 402 with an interior cooking chamber 404 defined by a top wall 412, a floor or bottom wall 414, a back wall 416, and a pair of opposing side walls 418. Cooking chamber 404 is configured for the receipt of one or more food items to be cooked. Oven appliance 400 includes a door 408 pivotally mounted to cabinet 402 at the opening 406 of cabinet 402 to permit selective access to cooking chamber 404 through opening 406. A handle 410 is mounted to door 408 and assists a user with opening and closing door 408. For example, a user can pull on handle 410 to open or close door 408 and access cooking chamber 404.

Oven appliance 400 can include a seal (not shown) between door 408 and cabinet 402 that assists with maintaining heat and cooking vapors within cooking chamber 404 when door 408 is closed as shown in FIGS. 1 and 2. Multiple parallel glass panes 422 provide for viewing the contents of cooking chamber 404 when door 408 is closed and assist with insulating cooking chamber 404. A baking rack 442 is positioned in cooking chamber 404 for the receipt of food items or utensils containing food items. Baking rack 442 is slidably received onto embossed ribs or sliding rails 444 such that rack 442 may be conveniently moved into and out of cooking chamber 404 when door 408 is open.

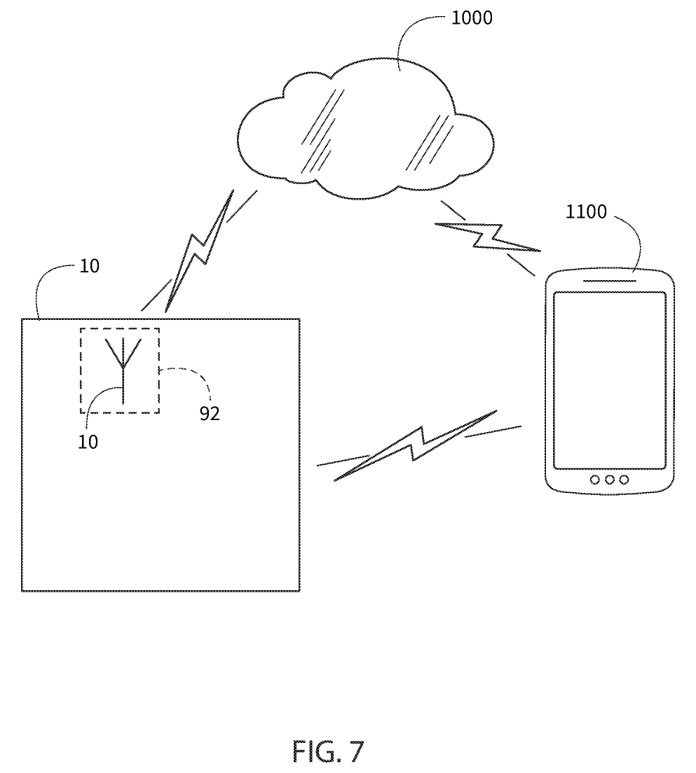

One or more heating elements may be included at the top, bottom, or both of cooking chamber 404 to provide heat to cooking chamber 404 for cooking. Such heating element(s) can be gas, electric, microwave, or a combination thereof. For example, in the embodiment shown in FIG. 7, oven appliance 400 includes a top heating element 424 which, in the illustrated example embodiment is an electric resistance heating element 424, and a bake heating element or bottom heating element 426, which, in the illustrated example embodiment is a gas burner 426, and bottom heating element 426 is positioned adjacent to and below bottom wall 414.

Also as may be seen in FIG. 2, the gas burner 426 is positioned within the cabinet 402 and outside of the chamber 404. In some embodiments, for example as illustrated in FIG. 7, the gas burner 426 may be a bake heating element or bottom heating element and may be positioned below the chamber 404 and separated from the chamber 404 by a partition, e.g., the bottom wall 414 of the chamber 404. The gas burner 426 may be in thermal communication and in fluid communication with the chamber by a flow path extending through one or more apertures or openings 460 in the bottom wall 414. In at least some embodiments, the flow path may extend from the gas burner 426, e.g., from ports thereof, through the opening(s) 460, and into the cooking chamber 404.

In the illustrated example embodiment, oven appliance 400 also has a convection heating element 436 and convection fan 438 positioned adjacent back wall 416 of cooking chamber 404. Convection fan 438 is powered by a convection fan motor 439. Further, convection fan 438 can be a variable speed fan – meaning the speed of fan 438 may be controlled or set anywhere between and including, e.g., zero and one hundred percent (0% - 100%). In certain embodiments, oven appliance 400 may also include a bidirectional triode thyristor (not shown), i.e., a triode for alternating current (TRIAC), to regulate the operation of convection fan 438 such that the speed of fan 438 may be adjusted during operation of oven appliance 400. The speed of convection fan 438 can be determined by controller 210 (not specifically illustrated in FIGS. 1 and 2, but which is similar to the controllers 210 described above). In addition, a sensor 437 such as, e.g., a rotary encoder, a Hall effect sensor, or the like, may be included at the base of fan 438, for example, between fan 438 and motor 439 as shown in the exemplary embodiment of FIG. 2, to sense the speed of fan 438. The speed of fan 438 may be measured in, e.g., revolutions per minute (RPM). In some embodiments, the convection fan 438 may be configured to rotate in two directions, e.g., a first direction of rotation and a second direction of rotation opposing the first direction of rotation. For example, in some embodiments, reversing the direction of rotation, e.g., from the first direction to the second direction or vice versa, may still direct air from the back of the cavity. As another example, in some embodiments reversing the direction results in air being directed from the top and/or sides of the cavity rather than the back of the cavity. Additionally, the convection heating features are optional and are shown and described herein solely by way of example. In other embodiments the oven appliance 400 may include different convection heating features or may not include convection heating features at all.

In various embodiments, more than one convection heater, e.g., more than one convection heating elements 436 and/or convection fans 438, may be provided. In such embodiments, the number of convection fans and convection heaters may be the same or may differ, e.g., more than one convection heating element 436 may be associated with a single convection fan 438. Similarly, more than one top heating element 424 and/or more than one bottom heating element 426 may be provided in various combinations, e.g., one top heating element 424 with two or more bottom heating elements 426, two or more bottom heating elements 426 with no top heating element 424, etc.

Oven appliance 400 includes a user interface 164 having a display 104 positioned on an interface panel 100 and having a variety of controls 102. Interface 164 allows the user to select various options for the operation of oven 400 including, e.g., various cooking and cleaning cycles. Operation of oven appliance 400 can be regulated by a controller 210 that is operatively coupled to, i.e., in communication with, user interface 164, heating elements 424, 426, and other components of oven 400 as will be further described. In some embodiments, display 104 can also be used as an input device. For instance, in such embodiments, display 104 can be a touchscreen device. In some embodiments, display 104 is the only input device on interface panel 164, e.g., the controls 102 may be omitted and the input functionality may be provided by the touchscreen display 104.

For example, in response to user manipulation of the user interface 164, the controller can operate the heating element(s). The controller can receive measurements from one or more temperature sensors (not shown) which are in or in thermal communication with the cooking chamber 404. The controller may also provide information such as a status indicator, e.g., a temperature indication, to the user with display 104.

Although shown with touch type controls 102, it should be understood that controls 102 and the configuration of oven appliance 400 shown in FIGS. 1 and 2 is provided by way of example only. More specifically, user interface 164 may include various input components, such as one or more of a variety of electrical, mechanical, or electro-mechanical input devices including rotary dials, push buttons, and touch pads. User interface 164 may include other display components, such as a digital or analog display device designed to provide operational feedback to a user. User interface 164 may be in communication with the controller via one or more signal lines or shared communication busses.

The present invention could also be used with other cooking appliances such as, e.g., a wall oven, a stand-alone oven, a cooktop, or other configurations of such cooking appliances. Numerous variations in the oven configuration are possible within the scope of the present subject matter. For example, variations in the type and/or layout of the controls 102 on the interface 164, as mentioned above, are possible. As another example, the oven appliance 400 may include multiple doors 408 instead of or in addition to the single door 408 illustrated. Such examples include a dual cavity oven, a French door oven, and others. As still another example, one or more of the illustrated heating elements may be substituted with microwave heating elements, or any other suitable heating elements. The examples described herein are provided by way of illustration only and without limitation.

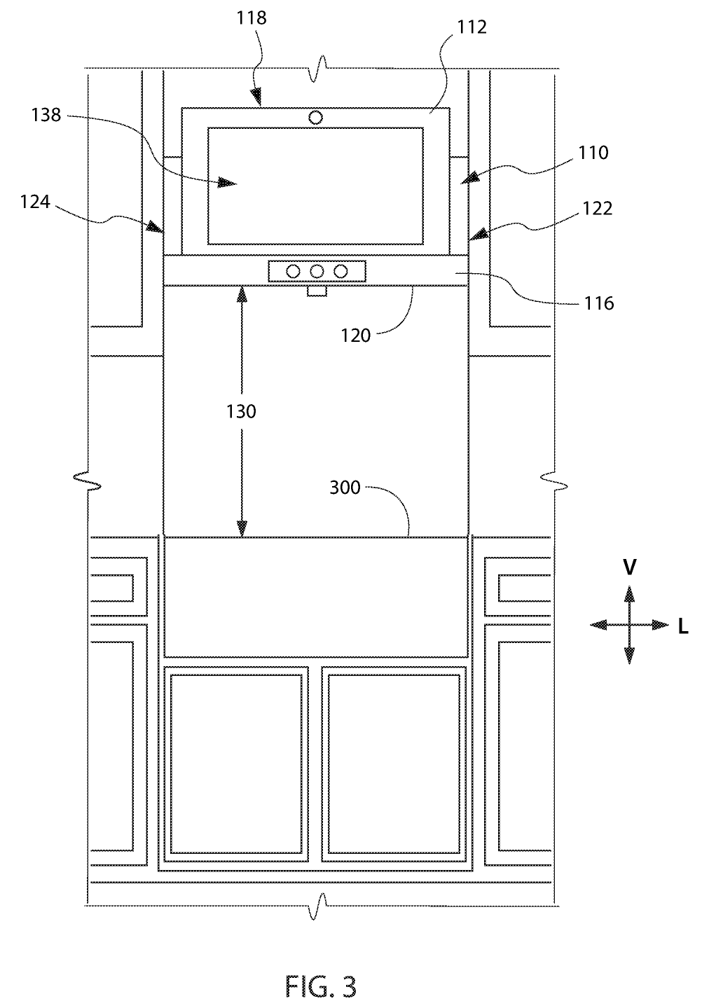

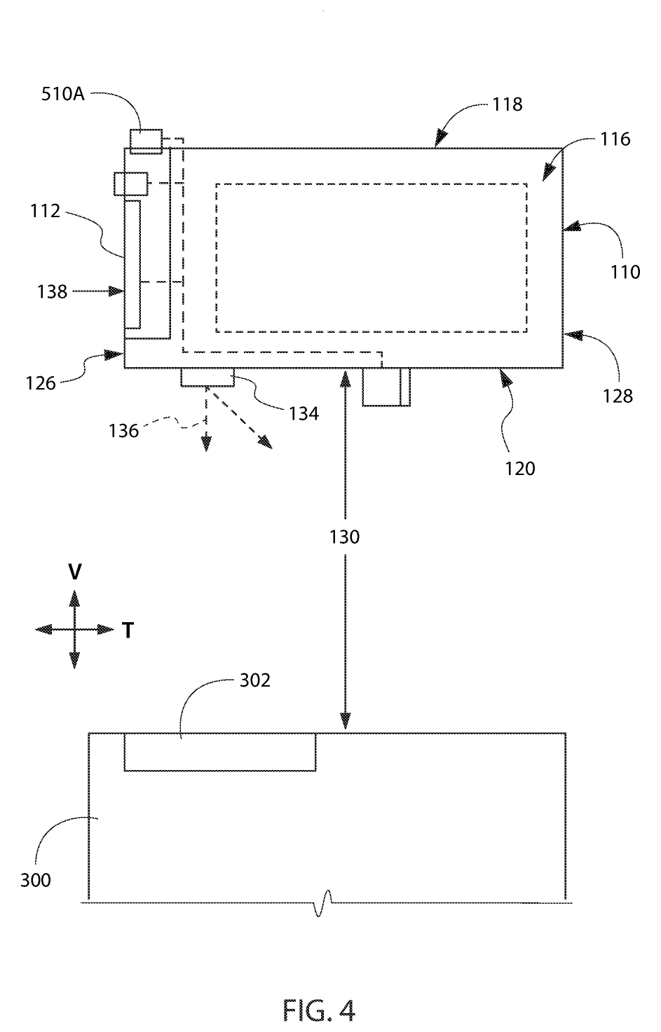

Turning now to FIGS. 3-5, various views are provided of a system according to exemplary embodiments of the present disclosure. The system generally includes an interactive assembly 110 (the interactive assembly 110 providing an example household appliance with which the cooking appliance, e.g., oven appliance 400 of FIGS. 1 and 2, may communicate and/or interoperate) having a controller 510A (FIG. 4) in operable communication with an image monitor 112 that is generally positioned above a countertop, and a sink 300 mounted in the countertop.

As shown, a casing 116 may be provided above the sink 300 along the vertical direction V. The casing 116 includes a plurality of outer walls and generally extends along the vertical direction V between a top end 118 and a bottom end 120, along the lateral direction L between a right side end 122 and a left side end 124, e.g., “right” and “left” as used herein refer to from a perspective of a user standing in front of the system. The casing 116 may also extend along the transverse direction T between a front end 126 and a back end 128. In some embodiments, casing 116 is spaced apart from sink 300 along the vertical direction V. An open region 130 may thus be defined along the vertical direction V between sink 300 and bottom end 120.

In optional embodiments, casing 116 may include a ventilation assembly within the casing 116 and may thus direct an airflow from the open region 130 and through the casing 116. However, a range hood is provided by way of example only. Other configurations may be used within the spirit and scope of the present disclosure. For example, although a generally rectangular shape is illustrated, any suitable shape or style may be adapted to form the structure of casing 116.

In some embodiments, the casing 116 may be a part of a user engagement system, e.g., the casing 116 may be a housing of an interactive assembly 110. The interactive assembly 110 may include an image monitor 112. In some embodiments, image monitor 112 may be provided above sink 300 (e.g., along the vertical direction V). For instance, image monitor 112 may be mounted to or supported in casing 116 (e.g., directly above the sink 300) proximal to the front end 126. Generally, image monitor 112 may be any suitable type of mechanism for visually presenting a digital (e.g., interactive) image. For example, image monitor 112 may be a liquid crystal display (LCD), a plasma display panel (PDP), a cathode ray tube (CRT) display, etc. Thus, image monitor 112 includes an imaging surface 138 (e.g., screen or display panel) at which the digital image is presented or displayed as an optically-viewable picture (e.g., static image or dynamic video) to a user. Optionally, a protective transparent panel (e.g., formed from a transparent glass, plastic, etc.) may be positioned across or over imaging surface 138. In some such embodiments, the protective transparent panel is mounted within or supported on hood casing 116 forward from imaging surface 138 along the transverse direction T.

The optically-viewable picture at the imaging surface 138 may correspond to any suitable signal or data received or stored by interactive assembly 110 (e.g., at controller 510A). As an example, image monitor 112 may present recipe information in the form of viewable text or images. As another example, image monitor 112 may present a remotely captured image, such as a live (e.g., real-time) dynamic video stream received from a separate user or device. As yet another example, image monitor 112 may present a graphical user interface (GUI) that allows a user to select or manipulate various operational features of interactive assembly 110 or oven appliance 400. During use of such GUI embodiments, a user may engage, select, or adjust the image presented at image monitor 112 through any suitable input, such as gesture controls detected through a camera assembly, voice controls detected through one or more microphones, associated touch panels (e.g., capacitance or resistance touch panel) sensors overlaid across imaging surface 138, or any other suitable input.

As illustrated, the imaging surface 138 is directed toward the area forward from the interactive assembly 110. During use, a user standing in front of interactive assembly 110 may thus see the optically-viewable picture (e.g., recipe, dynamic video stream, graphical user interface, etc.) displayed at the imaging surface 138. Optionally, the imaging surface 138 may be positioned at a rearward non-orthogonal angle relative to the vertical direction V. In other words, the imaging surface 138 may be inclined such that an upper edge of the imaging surface 138 is closer to the rear end 128 of casing 116 than a lower edge of the imaging surface 138 is. In some such embodiments, the non-orthogonal angle is between 1° and 15° relative to the vertical direction V. In certain embodiments, the non-orthogonal angle is between 2° and 7° relative to the vertical direction V.

In some embodiments, a camera assembly 134 may be provided above sink 300 (e.g., along the vertical direction V) and may be operable to obtain images within a field of view 136 of the camera assembly 134. Camera assembly 134 may include one or more cameras. For instance, camera assembly 134 may be mounted to casing 116 (e.g., directly above sink 300). So positioned, camera assembly 134 may obtain one or more images or videos of sink 300 or other objects (e.g., utensils such as a pot, pan, spoon, spatula, and the like) which may be positioned on or adjacent to the sink 300, such as in a drying rack 302 in or next to the sink 300. The interactive assembly 110 may further include a light that is positioned on or within casing 116, such as for selectively illuminating the sink 300 and any contents positioned therein. Although an exemplary camera assembly 134 is illustrated and described herein, it should be appreciated that according to alternative embodiments, interactive assembly 110 may include any other camera or system of imaging devices for obtaining images around the interactive assembly 110.

It should be appreciated that according to alternative embodiments, camera assembly 134 may include any suitable number, type, size, and configuration of camera(s) for obtaining images of any suitable areas or regions within and/or around the sink 300. In addition, it should be appreciated that each camera may include features for adjusting the field of view and/or orientation.

It should be appreciated that the images obtained by camera assembly 134 may vary in number, frequency, angle, resolution, detail, etc. in order to improve the clarity of the particular regions surrounding or within sink 300. In addition, according to exemplary embodiments, controller 510A may be configured for illuminating the sink 300 and/or surrounding areas using one or more light sources prior to obtaining images. Notably, controller 510A of interactive assembly 110 (or any other suitable dedicated controller) may be communicatively coupled to camera assembly 134 and may be programmed or configured for analyzing and/or processing the images obtained by camera assembly 134.

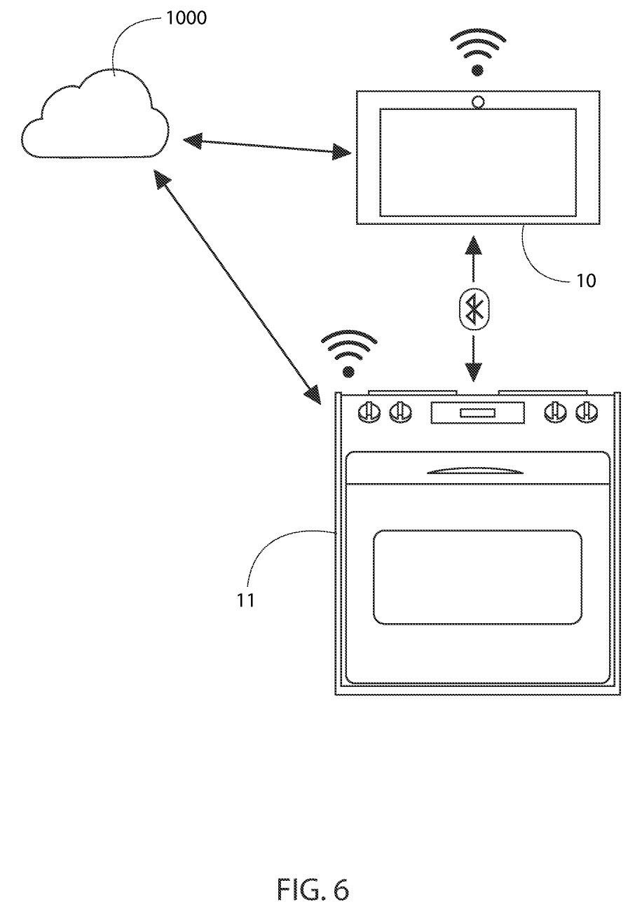

In general, controller 510A may be operably coupled to camera assembly 134 for analyzing, manipulating, synthesizing and/or otherwise processing one or more images obtained by camera assembly 134 to extract useful information regarding objects within the field of view of the one or more cameras. Notably, such processing may be performed locally (e.g., on controller 510A) or the images may be transmitted to a remote server (e.g., in the “cloud,” as those of ordinary skill in the art will recognize as referring to a remote server or database in a distributed computing environment including at least one remote computing device, e.g., as described below with reference to FIGS. 6 and 7) for analysis, processing, etc.

Notably, controller 510A of interactive assembly 110 (or any other suitable dedicated controller) may be communicatively coupled to camera assembly 134, a light, and other components of interactive assembly 110. As explained in more detail below, controller 510A may be programmed or configured for obtaining one or images around, e.g., below, interactive assembly 110, transmitting those images to a remote device (e.g., such as a user’s mobile phone 1100, e.g., as noted in FIG. 7), receiving feedback from the user’s remote device, and implementing responsive action based on that user input for improved performance and safety of operation.

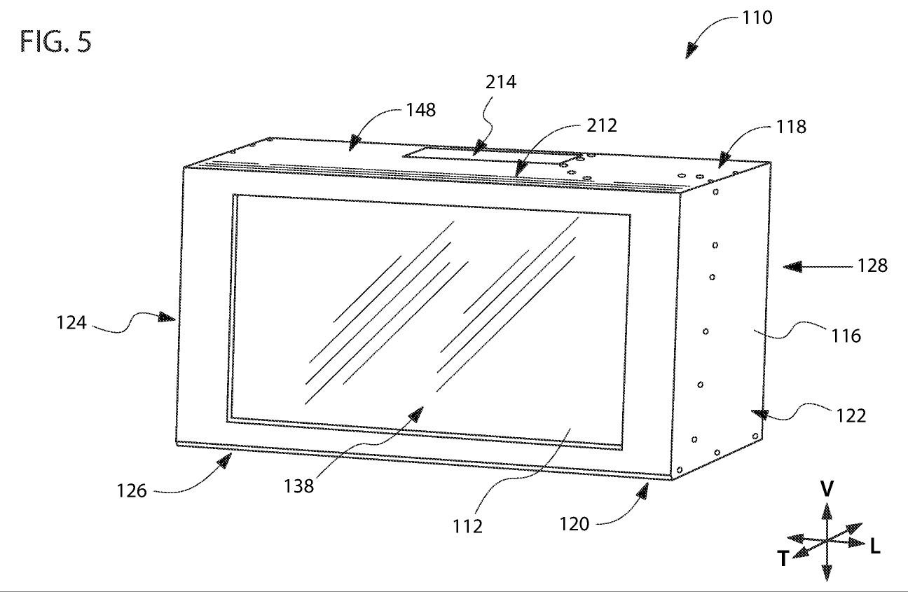

Turning now to FIG. 5, a perspective view of an exemplary embodiment of the interactive assembly 110 in isolation, e.g., without adjacent cabinetry or appliances, is provided. As shown, casing 116 extends in the vertical direction V from a top end 118 to a bottom end 120, the transverse direction T between a front end 126 and the rear end 128, and in the lateral direction L from the first side end 122 to a second side end 124. One or more air outlets 212 may be defined by casing 116 (e.g., through one or more external walls of casing 116) for use in optional embodiments wherein the casing 116 also provides ventilation and/or recirculation features. As shown for example in FIG. 5, air outlets 212 defined through hood casing 116 may be defined through hood casing 116 at the top end 118. For example, the top end 118 of the casing 116 may be defined by a top wall 148.

It should be understood that “household appliance” and/or “appliance” are used herein to describe appliances typically used or intended for common domestic tasks, such as a cooking appliance, a laundry appliance, an air conditioner appliance, a dishwashing appliance, a refrigerator, a water heater, etc., and any other household appliance which performs similar functions in addition to network communication and data processing. Accordingly, it will be recognized that the domestic task(s) which the appliance is configured to perform include operating on tangible matter (e.g., water, air, food items, laundry articles, and/or other such matter) to change a physical attribute (e.g., temperature, pressure, position, velocity, etc.) of the tangible matter using a mechanical component of the appliance. Thus, devices such as a personal computer, router, and other similar devices whose primary functions are network communication and/or data processing are not considered household appliances as used herein.

As used herein, the term “household” or “residence” includes a domestic structure or dwelling place in which one or more people eat, sleep, and/or spend leisure time. For example, a household (e.g., within which the household appliance is located and used) may be a dormitory, condo unit, apartment unit, townhome, single-family home, or other similar places. In additional embodiments, the household appliance or group of household appliances may also be located and/or used in a commercial setting, such as an office, a commercial kitchen, or a laundromat. Thus, it should be understood that the term “household appliances” is used herein to refer to the capabilities and functionalities of the appliances without necessarily limiting the appliances to a specific setting.

Turning now to FIG. 6 in particular, an exemplary embodiment including a household appliance 10 in communication with an oven appliance 11 is illustrated. For example, the oven appliance 11 may be any cooking appliance which includes a cooking cavity defined therein, such as cooking appliance 400 described above. The household appliance 10 and oven appliance 11 may be connected to one or more remote computing devices, e.g., a remote server, remote database, and/or one or more other such computing devices, e.g., in the cloud 1000. The household appliance 10 may be, for example, an interactive appliance such as the exemplary interactive assembly 110 described above. In additional embodiments, other suitable household appliances may be used, such as a dishwasher appliance, or a ventilation hood without an interactive display screen, among other possibilities.

FIG. 6 schematically illustrates household appliance 10 and oven appliance 11 in communication, e.g., wireless communication as illustrated in FIG. 6, with one or more remote computing devices in a distributed computing environment, such as a cloud 1000. For example, the household appliance 10, and in particular the controller (e.g., controller 510A) thereof, may be in communication with one or more remote computing devices, such as remote computers, servers, and/or databases, in the cloud 1000. As mentioned above, controller 510A is capable of and may be operable to perform any methods and associated method steps as disclosed herein. Additionally, performance of such methods and method steps may also be distributed, e.g., one or more steps of a method may be performed by the household appliance (e.g., controller thereof), while one or more other steps of the same method may be performed by another device, such as a remote computing device (e.g., in the cloud) and/or the oven appliance 10 (e.g., a controller thereof, such as controller 210 described above).

The household appliance 10 may also be in wireless communication with the oven appliance 11, e.g., via a direct wireless connection and/or indirect connection with data and other communications relayed between the household appliance 10 and the oven appliance 11 via a local network, such as a residential wireless network or other wireless local area network (“WLAN”), or via the internet, e.g., through the cloud 1000.

The household appliance 10 may be in communication with the oven appliance 11 through various possible communication connections and interfaces. The household appliance 10 and the oven appliance 11 may be matched in wireless communication, e.g., connected to the same wireless network. The household appliance 10 may communicate with the oven appliance 11 via short-range radio such as BLUETOOTH® or any other suitable wireless network having a layer protocol architecture. As used herein, “short-range” may include ranges less than about ten meters and up to about one hundred meters. For example, the wireless network may be adapted for short-wavelength ultra-high frequency (UHF) communications in a band between 2.4 GHz and 2.485 GHz (e.g., according to the IEEE 802.15.1 standard). In particular, BLUETOOTH® Low Energy, e.g., BLUETOOTH® Version 4.0 or higher, may advantageously provide short-range wireless communication between the household appliance 10 and the oven appliance 11. For example, BLUETOOTH® Low Energy may advantageously minimize the power consumed by the exemplary methods and devices described herein due to the low power networking protocol of BLUETOOTH® Low Energy.

In some embodiments, the performance of exemplary methods and associated method steps may be distributed, e.g., performed in part by the controller(s) 510A and/or 210 of the household appliance 10 and oven appliance 11, and in part by one or more remote computing devices in the cloud 1000. For example, data, which may include identifying information for the appliances 10 and 11 and version information, etc., may be transmitted from the appliances 10 and 11 to the cloud 1000. The data may be analyzed or processed remotely, e.g., in the cloud 1000, in embodiments which include distributed computing as described above.

Turning now to FIG. 7, a general schematic is provided of the household appliance 10, which communicates wirelessly with a remote user interface device 1100 and a network 1000, e.g., the cloud or other distributed computing environment such as the fog or the edge. Thus, it will be recognized by those of ordinary skill in the art that FIG. 7 schematically illustrates a household appliance 10, a cloud 1000, and a remote user interface device 1100, all of which are interconnected with each other, directly or indirectly, for communication between and among each of the foregoing devices. This communication may be achieved using any suitable communication protocols and interfaces, such as one or more wireless networks, to transfer useful information or data. For example, the interconnected devices may share consumer usage data, user preferences, appliance operating parameters, operating conditions, and/or other useful data or information. Sharing data between and among various appliances or other devices within the system, e.g., the exemplary system illustrated in FIG. 7, may result in improved overall system operation, including improved efficiency and performance of each appliance or other device individually and/or all appliances and other devices collectively.

Additionally, the features illustrated in FIG. 7 and described herein with respect to the generic household appliance 10 are equally applicable to any of the exemplary household appliance 10 and/or oven appliance 11 described above. As illustrated in FIG. 7, the household appliance 10 may include an antenna 90 by which the household appliance 10 communicates with, e.g., sends and receives signals to and from, the remote user interface device 1100. The antenna 90 may be part of, e.g., onboard, a communications module 92. The communications module 92 may be a wireless communications module operable to connect wirelessly, e.g., over the air, to one or more other devices via any suitable wireless communication protocol. For example, the communications module 92 may be a WI-FI® module, a BLUETOOTH® module, or a combination module providing both WI-FI® and BLUETOOTH® connectivity. The communications module 92 may be onboard the controller 510A or 210 or may be separate from the controller 510A or 210 and coupled to the controller 510A or 210, e.g., via a wired connection. The remote user interface device 1100 may be a laptop computer, smartphone, tablet, personal computer, wearable device, smart home system, and/or various other suitable devices.

The household appliance 10 may be in communication with the remote user interface device 1100 through various possible communication connections and interfaces. The household appliance 10 and the remote user interface device 1100 may be matched in wireless communication, e.g., connected to the same wireless network. The household appliance 10 may communicate with the remote user interface device 1100 via short-range radio such as BLUETOOTH® or any other suitable wireless network having a layer protocol architecture. As used herein, “short-range” may include ranges less than about ten meters and up to about one hundred meters. For example, the wireless network may be adapted for short-wavelength ultra-high frequency (UHF) communications in a band between 2.4 GHz and 2.485 GHz (e.g., according to the IEEE 802.15.1 standard). In particular, BLUETOOTH® Low Energy, e.g., BLUETOOTH® Version 4.0 or higher, may advantageously provide short-range wireless communication between the household appliance 10 and the remote user interface device 1100. For example, BLUETOOTH® Low Energy may advantageously minimize the power consumed by the exemplary methods and devices described herein due to the low power networking protocol of BLUETOOTH® Low Energy.

The remote user interface device 1100 is “remote” at least in that it is spaced apart from and not physically connected to the household appliance 10, e.g., the remote user interface device 1100 is a separate, stand-alone device from the household appliance 10 which communicates with the household appliance 10 wirelessly. Any suitable device separate from the household appliance 10 that is configured to provide and/or receive communications, information, data, or commands from a user may serve as the remote user interface device 1100, such as a smartphone (e.g., as illustrated in FIG. 7), smart watch, personal computer, smart home system, or other similar device. For example, the remote user interface device 1100 may be a smartphone operable to store and run applications, also known as “apps,” and some or all of the method steps disclosed herein may be performed by a smartphone app.

The remote user interface device 1100 may include a memory for storing and retrieving programming instructions. Thus, the remote user interface device 1100 may provide a remote user interface which may be an additional user interface to the user interface panel 100 (FIG. 1). For example, the remote user interface device 1100 may be a smartphone operable to store and run applications, also known as “apps,” and the additional user interface may be provided as a smartphone app.

As mentioned above, the household appliance 10 may also be configured to communicate wirelessly with a network 1000. The network 1000 may be, e.g., a cloud-based data storage system including one or more remote computing devices such as remote databases and/or remote servers, which may be collectively referred to as “the cloud.” For example, the household appliance 10 may communicate with the cloud 1000 over the Internet, which the household appliance 10 may access via WI-FI®, such as from a WI-FI® access point in a user’s home. The network, e.g., cloud, 1000 may be or may include any suitable remote computing system or environment, such as one or more remote computing devices with which the household appliance 10 communicates wirelessly and over a network, such as the internet. For example, cloud 1000 may be or may include a cloud-based data storage system including any suitable number, type, and configuration of remote computing devices such as remote databases, remote servers, network devices, and/or other external devices that are able to communicate with each other or are otherwise interconnected, which may be collectively referred to as a “cloud,” or other similar distributed computing environment, e.g., “fog,” or “edge.” For example, the household appliance 10 may communicate with the first cloud 1000 over the internet, which the household appliance 10 may access via WI-FI®, such as from a WI-FI® access point in a user’s home.

Now that the construction and configuration of household appliance 10 and oven appliance 11 have been presented according to an exemplary embodiment of the present subject matter, exemplary methods for operating a cooking appliance, such as the exemplary oven appliance 400 or 11 described above, are provided. In some embodiments, the oven appliance may be in communication with a household appliance, e.g., household appliance 110 or 10 described above, and the method may also include operating and/or interacting with the household appliance. In this regard, for example, controller 510A and/or 210 may be configured for implementing some or all steps of one or more of the following exemplary methods, such as the various method steps as disclosed herein may be performed locally, e.g., by controller 510A, 210, and/or a separate, dedicated controller integrated into the appliance(s) 10 and/or 11. Furthermore, some or all of the various method steps may be performed remotely, e.g., in a distributed computing environment such as the cloud, fog, or edge, wherein the controller 510A and/or 210 communicates with one or more remote computing devices of the distributed computing environment, such as data processing and/or analysis, may be performed in the cloud and the output of such process may be transmitted to and received by the household appliance(s) 10 and 11, such as by the controller(s) 510 or 210 thereof via the communications module 92. It should be appreciated, however, that the exemplary methods are discussed herein only to describe exemplary aspects of the present subject matter, and are not intended to be limiting.

Further, methods according to the present disclosure are not necessarily limited to the exemplary appliances described or illustrated. For example, the oven appliance may include various combinations of heating modules and/or heating elements as in any of the foregoing examples, such as an oven appliance with only electric radiant heating (e.g., without convection), an oven appliance with gas bake heating element and convection heating, an oven appliance with ceramic heating modules and heat lamps, among numerous other possible combinations.

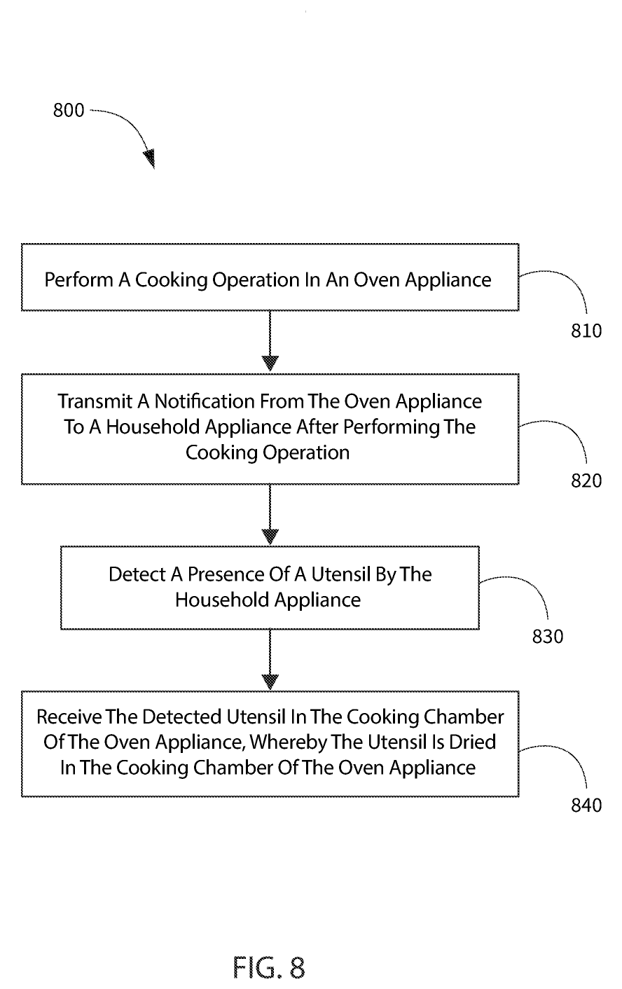

An exemplary method 800 is illustrated in FIG. 8. Method 800 may be used to operate any suitable cooking appliance, such as a cooking appliance which includes a cabinet, a cooking chamber defined within the cabinet for cooking food items therein, and a heating element in thermal communication with the cooking chamber for providing cooking energy to the cooking chamber. In some embodiments, for example, method 800 may be used to dry and sterilize a utensil in the cooking appliance.

Methods according to various embodiments of the present disclosure may include performing a cooking operation in the oven appliance, e.g., as indicated at 810 in FIG. 8. The cooking operation generally includes activating the heating element to provide cooking energy to the cooking chamber. Method 800 also includes (840) receiving the utensil in the cooking chamber of the oven appliance after the cooking operation. As a result, the utensil is dried in the cooking chamber of the oven appliance. For example, the utensil may be received within the cooking chamber after the cooking operation is completed, e.g., when the heating element is no longer activated, but shortly enough after the cooking operation that the cooking chamber remains warm, e.g., at a temperature greater than room temperature within the cooking chamber, where room temperature is understood to be between about 60 °F and about 75 °F. For example, the residual heat within the cooking chamber may include internal temperatures inside the cooking chamber of about 100 °F or more, such as about 150 °F or more, such as about 200 °F or more, such as about 250 °F or more, such as about 300 °F or more, such as about 320 °F or more. For example, in embodiments which also include sterilizing the utensil in the cooking appliance, the internal temperature inside the cooking chamber at the end of the cooking operation may be about 350 °F or more, such as about 400 °F or about 500 °F.

Method 800 may, in some embodiments further include utilizing an additional household appliance. For example, as shown in FIG. 8, the method 800 may further include (820) transmitting, from the oven appliance, a notification to a household appliance after performing the cooking operation and (830) detecting, by the household appliance, a presence of a utensil. In such embodiments, the utensil which is received at (840) may be the detected utensil. In one particular example, the oven appliance 400 may transmit a notification to the interactive assembly 110 when the cooking operation is complete, and, in response to such notification, the interactive assembly 110 may check for the presence of a utensil, such as using the camera assembly 134 to obtain an image which includes the drying rack 302 and analyzing the image to determine or detect the presence of a utensil, e.g., in the drying rack. Continuing the example, when the utensil is detected, a user notification may be provided, such as by the interactive assembly 110 and/or a remote computing device (e.g., in the cloud), on one or more of the image monitor of the interactive assembly, a display of the cooking appliance, and/or a remote user interface device.

According to exemplary embodiments of the present subject matter, detecting the utensil may include obtaining one or more images of the utensil. Although the term “image” is used herein, it should be appreciated that according to exemplary embodiments, camera assembly 134 may take any suitable number or sequence of two-dimensional images, videos, or other visual representations of a cooking utensil, cooktop 450, sink 300, and/or drying rack 302, such as the utensil (if present) may be located in the drying rack after washing in order to air dry the utensil. Thus, the residual heat in the cooking appliance may advantageously be used to dry (e.g., more quickly and thoroughly than air-drying alone) the utensil and, optionally when the residual heat is sufficient, sterilize the utensil. For example, the one or more images may include a video feed or series of sequential static images obtained by camera assembly 134 that may be transmitted to the controller 510A and/or 210 (e.g., as a data signal) for analysis or other manipulation. These obtained images may vary in number, frequency, angle, field-of-view, resolution, detail, etc.

Detecting the utensil may include analyzing the one or more images to identify the utensil, e.g., in the drying rack or on a countertop, etc., such as generally within the field of view 136 below the interactive assembly 110. According to exemplary embodiments, this image analysis may use any suitable image processing technique, image recognition process, etc. As used herein, the terms “image analysis” and the like may be used generally to refer to any suitable method of observation, analysis, image decomposition, feature extraction, image classification, etc. of one or more images, videos, or other visual representations of an object. As explained in more detail below, this image analysis may include the implementation of image processing techniques, image recognition techniques, or any suitable combination thereof. In this regard, the image analysis may use any suitable image analysis software or algorithm to constantly or periodically monitor for the presence of the utensil, e.g., in the drying rack 302. It should be appreciated that this image analysis or processing may be performed locally (e.g., by controller 510A and/or 210) or remotely (e.g., by offloading image data to a remote server or network).

Specifically, the analysis of the one or more images may include implementation an image processing algorithm. As used herein, the terms “image processing” and the like are generally intended to refer to any suitable methods or algorithms for analyzing images that do not rely on artificial intelligence or machine learning techniques (e.g., in contrast to the machine learning image recognition processes described below). For example, the image processing algorithm may rely on image differentiation, e.g., such as a pixel-by-pixel comparison of two sequential images. This comparison may help identify substantial differences between the sequentially obtained images, e.g., to identify movement, the presence of a particular object (e.g., the utensil), the existence of a certain condition, etc. For example, one or more reference images may be obtained when a particular condition exists (such as the condition may be an object/utensil in the drying rack), and these reference images may be stored for future comparison with images obtained during appliance operation (or immediately after a cooking appliance operation and/or in response to a notification from the cooking appliance which is sent at the end of the cooking operation). Similarities and/or differences between the reference image and the obtained image may be used to extract useful information for improving appliance performance.

According to exemplary embodiments, image processing may include blur detection algorithms that are generally intended to compute, measure, or otherwise determine the amount of blur in an image. For example, these blur detection algorithms may rely on focus measure operators, the Fast Fourier Transform along with examination of the frequency distributions, determining the variance of a Laplacian operator, or any other methods of blur detection known by those having ordinary skill in the art. In addition, or alternatively, the image processing algorithms may use other suitable techniques for recognizing or identifying items or objects, such as edge matching or detection, divide-and-conquer searching, greyscale matching, histograms of receptive field responses, or another suitable routine (e.g., executed at the controller 510A and/or 210 based on one or more captured images from one or more cameras). Other image processing techniques are possible and within the scope of the present subject matter. The processing algorithm may further include measures for isolating or eliminating noise in the image comparison, e.g., due to image resolution, data transmission errors, inconsistent lighting, or other imaging errors. By eliminating such noise, the image processing algorithms may improve accurate object detection, avoid erroneous object detection, and isolate the important object, region, or pattern within an image.

In addition to the image processing techniques described above, the image analysis may include utilizing artificial intelligence (“AI”), such as a machine learning image recognition process, a neural network classification module, any other suitable artificial intelligence (AI) technique, and/or any other suitable image analysis techniques, examples of which will be described in more detail below. Moreover, each of the exemplary image analysis or evaluation processes described below may be used independently, collectively, or interchangeably to extract detailed information regarding the images being analyzed to facilitate performance of one or more methods described herein or to otherwise improve appliance operation. According to exemplary embodiments, any suitable number and combination of image processing, image recognition, or other image analysis techniques may be used to obtain an accurate analysis of the obtained images.

In this regard, the image recognition process may use any suitable artificial intelligence technique, for example, any suitable machine learning technique, or for example, any suitable deep learning technique. According to an exemplary embodiment, the image recognition process may include the implementation of a form of image recognition called region based convolutional neural network (“R-CNN”) image recognition. Generally speaking, R-CNN may include taking an input image and extracting region proposals that include a potential object or region of an image. In this regard, a “region proposal” may be one or more regions in an image that could belong to a particular object or may include adjacent regions that share common pixel characteristics. A convolutional neural network is then used to compute features from the region proposals and the extracted features will then be used to determine a classification for each particular region.

According to still other embodiments, an image segmentation process may be used along with the R-CNN image recognition. In general, image segmentation creates a pixel-based mask for each object in an image and provides a more detailed or granular understanding of the various objects within a given image. In this regard, instead of processing an entire image—i.e., a large collection of pixels, many of which might not contain useful information—image segmentation may involve dividing an image into segments (e.g., into groups of pixels containing similar attributes) that may be analyzed independently or in parallel to obtain a more detailed representation of the object or objects in an image. This may be referred to herein as “mask R-CNN” and the like, as opposed to a regular R-CNN architecture. For example, mask R-CNN may be based on fast R-CNN which is slightly different than R-CNN. For example, R-CNN first applies a convolutional neural network (“CNN”) and then allocates it to zone recommendations on the property map of one of the convolutional layers instead of the initially split into zone recommendations. In addition, according to exemplary embodiments, standard CNN may be used to obtain, identify, or detect any other qualitative or quantitative data related to one or more objects or regions within the one or more images. In addition, a K-means algorithm may be used.

According to still other embodiments, the image recognition process may use any other suitable neural network process while remaining within the scope of the present subject matter. For example, the step of analyzing the one or more images may include using a deep belief network (“DBN”) image recognition process. A DBN image recognition process may generally include stacking many individual unsupervised networks that use each network’s hidden layer as the input for the next layer. According to still other embodiments, the step of analyzing one or more images may include the implementation of a deep neural network (“DNN”) image recognition process, which generally includes the use of a neural network (computing systems inspired by the biological neural networks) with multiple layers between input and output. Other suitable image recognition processes, neural network processes, artificial intelligence analysis techniques, and combinations of the above described or other known methods may be used while remaining within the scope of the present subject matter.

In addition, it should be appreciated that various transfer techniques may be used but use of such techniques is not required. If using transfer techniques learning, a neural network architecture may be pretrained such as VGG16 / VGG19 / ResNet50 with a public dataset then the last layer may be retrained with an appliance specific dataset. In addition, or alternatively, the image recognition process may include detection of certain conditions based on comparison of initial conditions, may rely on image subtraction techniques, image stacking techniques, image concatenation, etc. For example, the subtracted image may be used to train a neural network with multiple classes for future comparison and image classification.

It should be appreciated that the machine learning image recognition models may be actively trained by the appliance with new images, may be supplied with training data from the manufacturer or from another remote source, or may be trained in any other suitable manner. For example, according to exemplary embodiments, this image recognition process relies at least in part on a neural network trained with a plurality of images of the appliance in different configurations, experiencing different conditions, or being interacted with in different manners. This training data may be stored locally or remotely and may be communicated to a remote server for training other appliances and models. According to exemplary embodiments, it should be appreciated that the machine learning models may include supervised and/or unsupervised models and methods. In this regard, for example, supervised machine learning methods (e.g., such as targeted machine learning) may help identify problems, anomalies, or other occurrences which have been identified and trained into the model. By contrast, unsupervised machine learning methods may be used to detect clusters of potential failures, similarities among data, event patterns, abnormal concentrations of a phenomenon, etc.

It should be appreciated that image processing and machine learning image recognition processes may be used together to facilitate improved image analysis, object detection, or to extract other useful qualitative or quantitative data or information from the one or more images that may be used to improve the operation or performance of the appliance. Indeed, the methods described herein may use any or all of these techniques interchangeably to improve image analysis process and facilitate improved appliance performance and consumer satisfaction. The image processing algorithms and machine learning image recognition processes described herein are only exemplary and are not intended to limit the scope of the present subject matter in any manner.

For example, in some embodiments, the household appliance may include a camera. In such embodiments, detecting the presence of the utensil may include obtaining an image with the camera of the household appliance and analyzing the obtained image to detect the presence of the utensil. Analyzing the obtained image may include any of the foregoing techniques or other similar techniques, including combinations of techniques.

In some embodiments, the end of the cooking operation may be determined or detected when a door of the cooking appliance is opened, e.g., signifying that a user has removed the food item(s), and then closed. For example, in some embodiments methods according to the present disclosure may include detecting movement of a door of the oven appliance to a closed position, such as with a door position sensor, e.g., a switch which is closed by the door when the door is in the closed position. In such embodiments, the notification may be transmitted to the household appliance in response to detecting (by the oven appliance) the movement of the door of the oven appliance to the closed position.

When the utensil is detected, methods according to the present disclosure may include providing a user notification to place the utensil in the oven appliance in response to detecting the presence of the utensil. For example, the user notification may be provided on a display screen of the household appliance, such as the image monitor 112 of the exemplary interactive assembly 110 described above. As another example, the user notification is provided on a remote user interface device, such as on a display screen of a smartphone (e.g., as illustrated in FIG. 7) or smartwatch, tablet computer, or other similar user interface device which is remote (e.g., separate and apart from, and in wireless communication with) to the cooking appliance.

As mentioned above, in some embodiments, the utensil may be not only dried but also sterilized using the residual heat in the cooking chamber, e.g., when the cooking operation temperature(s) is or are high enough, such as at least about 320 °F. Thus, in some embodiments, methods according to the present disclosure may include determining a temperature in the cooking chamber during the cooking operation met or exceeded a sterilization threshold. The sterilization threshold may be about 320 °F or higher, such as about 340 °F or higher, such as about 350 °F. In such embodiments, the utensil may be dried and sterilized in the cooking chamber of the oven appliance.

Methods according to the present disclosure may advantageously capture and utilize residual heat which otherwise may be wasted. For example, some embodiments of such methods may include using only residual heat, e.g., whereby the detected utensil is dried in the oven appliance without reactivating the heating element of the cooking appliance after the cooking operation.

Referring again to FIG. 8, method steps are depicted in a particular order for purposes of illustration and discussion. Those of ordinary skill in the art, using the disclosures provided herein, will understand that (except as otherwise indicated) the steps of method 800 can be modified, adapted, rearranged, omitted, interchanged, or expanded in various ways without deviating from the scope of the present disclosure. Thus, those of ordinary skill in the art will recognize that the various steps of the exemplary methods described herein may be combined in various ways to arrive at additional embodiments within the scope of the present disclosure.

Furthermore, the skilled artisan will recognize the interchangeability of various features from different embodiments. Similarly, the various method steps and features described, as well as other known equivalents for each such methods and feature, can be mixed and matched by one of ordinary skill in this art to construct additional systems and techniques in accordance with principles of this disclosure. Of course, it is to be understood that not necessarily all such objects or advantages described above may be achieved in accordance with any particular embodiment. Thus, for example, those skilled in the art will recognize that the systems and techniques described herein may be embodied or carried out in a manner that achieves or optimizes one advantage or group of advantages as taught herein without necessarily achieving other objects or advantages as may be taught or suggested herein.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A method of operating an oven appliance, the oven appliance comprising a cabinet, a cooking chamber defined within the cabinet for cooking food items therein, and a heating element in thermal communication with the cooking chamber for providing cooking energy to the cooking chamber, the method comprising:
performing a cooking operation in the oven appliance, the cooking operation comprising activating the heating element to provide cooking energy to the cooking chamber;
transmitting, from the oven appliance, a notification to a household appliance after performing the cooking operation;
detecting, by the household appliance, a presence of a utensil; and
receiving the detected utensil in the cooking chamber of the oven appliance, whereby the utensil is dried in the cooking chamber of the oven appliance.

2. The method of claim 1, wherein the household appliance comprises a camera, wherein detecting the presence of the utensil comprises obtaining an image with the camera of the household appliance and analyzing the obtained image to detect the presence of the utensil.

3. The method of claim 1, further comprising detecting movement of a door of the oven appliance to a closed position, wherein the notification is transmitted to the household appliance in response to detecting the movement of the door of the oven appliance to the closed position.

4. The method of claim 1, further comprising providing a user notification to place the utensil in the oven appliance in response to detecting the presence of the utensil.

5. The method of claim 4, wherein the user notification is provided on a display screen of the household appliance.

6. The method of claim 4, wherein the user notification is provided on a remote user interface device.

7. The method of claim 1, further comprising determining a temperature in the cooking chamber during the cooking operation met or exceeded a sterilization threshold, wherein the utensil is dried and sterilized in the cooking chamber of the oven appliance.

8. The method of claim 1, wherein the detected utensil is dried in the oven appliance without reactivating the heating element of the oven appliance after the cooking operation.

9. The method of claim 1, wherein transmitting the notification from the oven appliance to the household appliance comprises transmitting the notification directly to the household appliance via a short-range radio signal.

10. The method of claim 1, wherein transmitting the notification from the oven appliance to the household appliance comprises transmitting the notification to the household appliance through a distributed computing system.

11. A method of drying a utensil in an oven appliance, the oven appliance comprising a cabinet, a cooking chamber defined within the cabinet for cooking food items therein, and a heating element in thermal communication with the cooking chamber for providing cooking energy to the cooking chamber, the method comprising:
performing a cooking operation in the oven appliance, the cooking operation comprising activating the heating element to provide cooking energy to the cooking chamber; and
receiving the utensil in the cooking chamber of the oven appliance after the cooking operation, whereby the utensil is dried in the cooking chamber of the oven appliance.

12. The method of claim 11, further comprising determining a temperature in the cooking chamber during the cooking operation met or exceeded a sterilization threshold, wherein the utensil is dried and sterilized in the cooking chamber of the oven appliance.

13. The method of claim 11, wherein the utensil is dried in the oven appliance without reactivating the heating element of the oven appliance after the cooking operation.

14. The method of claim 11, further comprising transmitting, from the oven appliance, a notification to a household appliance after performing the cooking operation and detecting, with the household appliance, a presence of the utensil.

15. The method of claim 14, wherein the household appliance comprises a camera, wherein detecting the presence of the utensil comprises obtaining an image with the camera of the household appliance and analyzing the obtained image to detect the presence of the utensil.

16. The method of claim 14, further comprising detecting movement of a door of the oven appliance to a closed position, wherein the notification is transmitted to the household appliance in response to detecting the movement of the door of the oven appliance to the closed position.

17. The method of claim 14, further comprising providing a user notification to place the utensil in the oven appliance in response to detecting the presence of the utensil.

18. The method of claim 14, wherein transmitting the notification from the oven appliance to the household appliance comprises transmitting the notification directly to the household appliance via a short-range radio signal.

19. The method of claim 14, wherein transmitting the notification from the oven appliance to the household appliance comprises transmitting the notification to the household appliance through a distributed computing system.
